(19) United States
(12) Patent Application Publication
(10) Pub. No.: US 2011/0130903 A1
(43) Pub. Date: Jun. 2, 2011

(54) TORQUE COMMAND STRUCTURE FOR AN ELECTRIC MOTOR

(75) Inventors: Adam J. Heisel, Garden City, MI (US); William R. Cawthorne, Milford, MI (US); Sean W. McGrogan, Ann Arbor, MI (US); John L. Lahti, Novi, MI (US)

(73) Assignee: GM GLOBAL TECHNOLOGY OPERATIONS, INC., Detroit, MI (US)

(21) Appl. No.: 12/627,193

(22) Filed: Nov. 30, 2009

(51) Int. Cl. B60W 20/00

(52) U.S. Cl. 701/22; 903/903; 903/906

(57) ABSTRACT

A method controls a motor generator unit (MGU) aboard a vehicle. An event signal is generated using a transmission controller, with the event signal predicting a transient vehicle event, e.g., auto start, transmission shift, fuel cycling, etc. The event signal is received by a motor controller, which determines a predicted level of motor output torque required from the MGU during the transient vehicle. Electromagnetic flux of the MGU is increased to a calibrated threshold level prior to commencement of the transient vehicle event. The MGU may be used for regenerating energy during the transient vehicle event. The MGU is then used to facilitate execution of the transient vehicle event. A vehicle having the MGU uses a controller(s) to automatically increase electromagnetic flux of the MGU prior to the transient vehicle event using the method as noted above.

### TECHNICAL FIELD

The present invention relates generally to a torque command structure for an electric motor, and more particularly to a method and a motor controller adapted for controlling a motor generator unit (MGU) of the type used for propelling a vehicle.

### BACKGROUND OF THE INVENTION

Certain vehicle designs such as hybrid electric vehicles (HEV) can selectively utilize different energy sources to optimize fuel efficiency. For example, an HEV having a full hybrid powertrain can use either or both of an internal combustion engine and a high-voltage energy storage system (ESS) for propulsive torque. Such HEVs can be electrically propelled, usually immediately upon starting the HEV and at relatively low vehicle speeds. One or more motor/generator units (MGU) may alternately draw power from and deliver power to the ESS as needed for onboard regeneration, further optimizing fuel economy.

Upon vehicle launch or above a threshold speed, the engine can be restarted using the MGU or a smaller auxiliary starter motor, i.e., an auto start event, and can be engaged thereafter with a transmission to provide the required vehicle propulsive torque to a set of drive wheels. An MGU aboard a typical HEV may be configured as a relatively high-voltage, permanent magnet machine, or a multi-phase alternating current (AC) induction-type machine. Depending on the configuration, the MGU may require generation of a calibrated amount of electromagnetic flux to produce the required motor output torque. In order to optimize efficiency, the flux levels of vehicular MGUs are ordinarily maintained at a minimal level.

### SUMMARY OF THE INVENTION

Accordingly, a torque command structure is provided that allows a motor generator unit (MGU), e.g., an AC induction-type machine or any other MGU design having the ability to increase its torque response as set forth herein, to be used to facilitate execution of a future transient event aboard a vehicle, while also allowing the MGU to regenerate energy during the transient event. Such a vehicle may be configured as a hybrid electric vehicle (HEV) according to one embodiment, and may include a high-voltage MGU that is adapted to assist the transient vehicle event, e.g., an automatic starting of the engine or an auto start event, as well as other predetermined transient vehicle events as set forth below.

The torque command structure may be embodied in algorithm form, and may be automatically executed via an onboard controller, e.g., a motor controller, in response to an event signal from the same controller or from another controller aboard the vehicle. Execution of the algorithm enables the MGU to be used as a “fast” actuator, as defined below, to facilitate execution of the predetermined transient vehicle event, and to allow the MGU to operate as either a motor or a generator during the transient event as required by the particular transient event being executed.

The torque command structure improves the response rate of the MGU by creating separate torque command signals, including an immediate torque signal for any immediately required motor output torque, and a predicted torque signal for motor output torque required for the predicted or future transient vehicle event. That is, the present invention looks ahead to an upcoming predetermined transient vehicle event, defined as a transient event that has not yet commenced but that is certain to occur within a predetermined timeframe, e.g., in less than approximately 500 milliseconds (ms), based on vehicle operating values such as engine speed, transmission output speed, accelerator pedal position, etc.

When the upcoming transient vehicle event is indicated via the event signal, the predicted torque signal is generated by a motor controller to describe a required level of motor output torque required for the duration of the upcoming transient vehicle event. Electromagnetic flux of the MGU is automatically increased to a calibrated maximum level exceeding the level of the immediate torque signal. The MGU thereby becomes available for use as a fast actuator facilitating rapid execution of the predetermined transient vehicle event, e.g., an auto start event, a transmission gear shift event, or a fuel cycling event.

In particular, a method is provided for controlling an MGU aboard a vehicle. The method includes generating an event signal, with the event signal predicting a future occurrence of a predetermined transient vehicle event. This signal may be generated by an onboard controller, e.g., a transmission controller, motor controller, or other suitable controller. The method also includes processing the event signal, determining a predicted level of motor output torque that will be required from the MGU during the predetermined transient vehicle event, and automatically increasing an amount of electromagnetic flux of the MGU to a calibrated threshold level prior to commencement of the transient vehicle event. The MGU is then used to facilitate an execution of the transient vehicle event.

A vehicle is also provided herein that includes an MGU, and at least one controller adapted for generating and processing the event signal to determine a predicted level of motor output torque required from the MGU during the predetermined transient vehicle event, and for controlling the MGU to facilitate an execution of the transient vehicle event. The controller includes an algorithm for automatically increasing the electromagnetic flux of the MGU to a calibrated threshold level prior to commencement of the transient vehicle event.

A controller is also provided herein for controlling an MGU aboard a vehicle. The controller, which may be a single or multiple controllers, is adapted for generating an event signal that predicts a future occurrence of a predetermined transient vehicle event. The controller includes a host machine and an algorithm for automatically increasing an amount of electromagnetic flux of the MGU to a calibrated threshold level prior to commencement of the transient vehicle event. The controller processes the event signal to determine a predicted level of motor output torque required from the MGU during the transient vehicle event, and controls the MGU to facilitate an execution of the transient vehicle event.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a vehicle having a controller with an algorithm or method for providing a torque command structure in accordance with the invention;

FIG. 2 is a graphical flow chart describing the algorithm usable with the vehicle shown in FIG. 1; and

FIG. 3 is a set of torque curves for the vehicle shown in FIG. 1.

### DESCRIPTION OF THE PREFERRED EMBODIMENTS

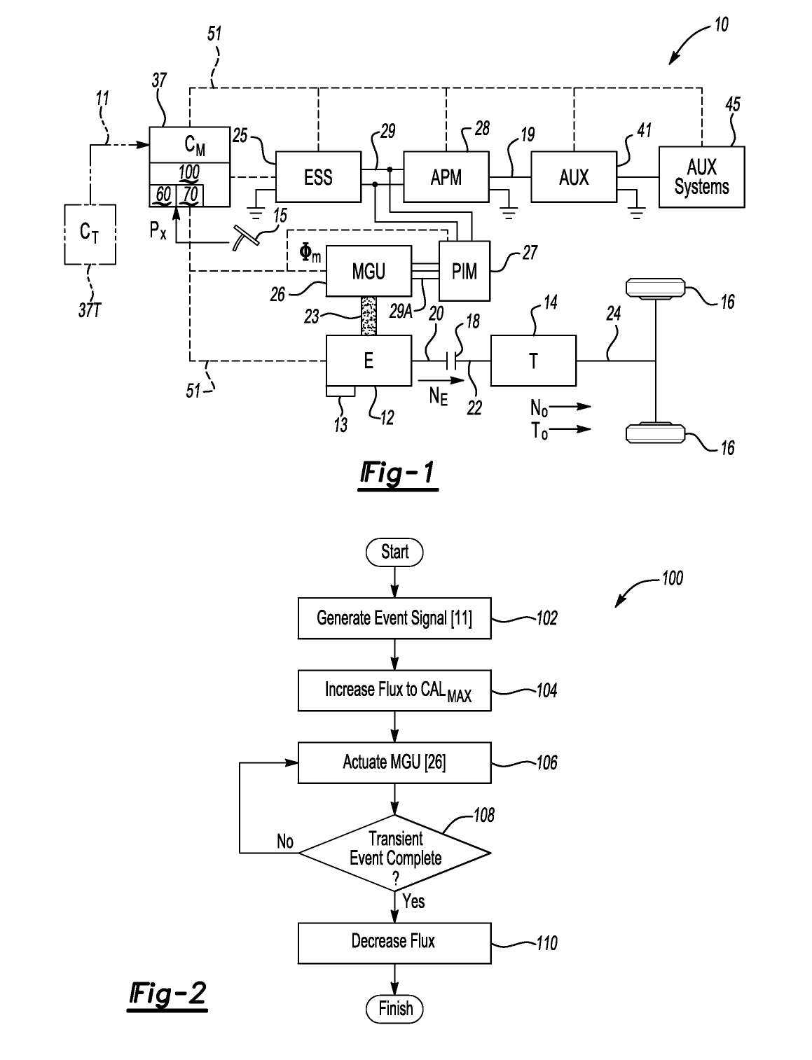

Referring to the drawings, wherein like reference numbers correspond to like or similar components throughout the several figures, FIG. 1 shows a vehicle 10 having an engine (E) 12 having an engine speed (N_{E}). The vehicle 10 also includes a transmission (T) 14 having an output member 24, with the output member having an output speed (N_{O}) and an output torque (T_{O}). Control authority over the various powertrain-related processes, functions, and operations of the vehicle 10 may reside in a first controller (C_{T}) 37T, here representing a transmission controller, and a second controller (C_{M}) 37, here representing a motor controller. Alternately, the controllers 37, 37T may be integrated into a single device, without departing from the intended scope of the invention.

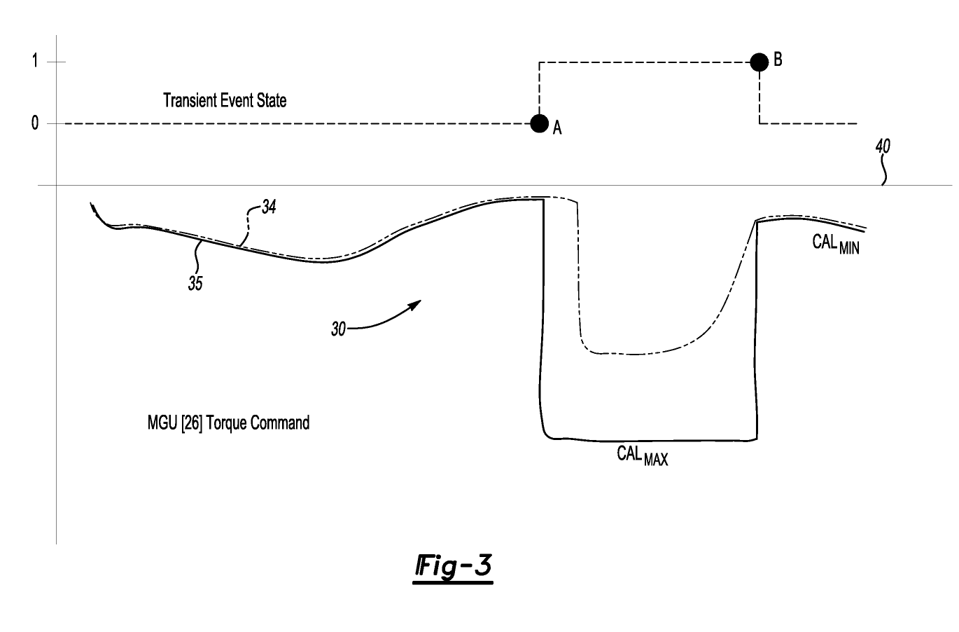

The controller 37 has an algorithm 100 adapted for executing the torque command structure via the method of the present invention, as set forth in detail below. The vehicle 10 may be configured as a hybrid electric vehicle (HEV) with selective propulsion provided via a motor generator unit (MGU) 26. In one embodiment, the MGU 26 is configured as a high-voltage alternating current (AC) induction-type electric machine, although other MGU designs adapted for use with the torque structure set forth herein are also usable within the scope of the invention. Also, while only one MGU 26 is shown, the vehicle 10 may include any number of MGUs without departing from the intended scope of the invention. The controller 37 and algorithm 100 are adapted to automatically and temporarily increase a commanded electromagnetic flux (Φ_{M}) of MGU 26 before onset or commencement of a predetermined transient vehicle event with respect to an optimally-efficient or calibrated minimum flux level, i.e., an immediate torque requirement, doing so via a dual-value torque command structure as detailed in FIGS. 2 and 3.

The vehicle 10 is adapted for building up a level of flux in advance of executing various transient vehicle events. As used herein, the term “transient vehicle event” refers to one or more of an auto start event, i.e., an event wherein the MGU 26 is used as a motor to restart the engine 12 after an engine auto stop event, an automatic gear shift of the transmission 14, and a fuel event, e.g., a cycling of an electronic fuel injector system 13. These transient events may be characterized by a sudden, large change in the motor torque command from zero to a relatively large torque value, i.e., flux is not already built up upon initiation of these transient events. The MGU 26 may operate as a motor or as a generator as needed, with regeneration provided when the MGU is operating as a generator.

Within the scope of the invention, the controller 37 controls the operation of at least the MGU 26, and in particular the commanded flux level (Φ_{M}) and torque generation of the MGU in anticipation of one of the predetermined transient vehicle events noted above. That is, the controller 37, via algorithm 100, automatically predicts an imminent future occurrence of a transient vehicle event based on an event signal 11. Event signal 11 may be provided from the controller 37T when a distributed controller is used aboard the vehicle 10, or it may be generated internally by the controller 37 if an integrated controller is used.

In one embodiment, “imminent” refers to a period of approximately 500 milliseconds (ms) prior to commencement of the predetermined transient vehicle event, with the event signal 11 communicating both the type of transient vehicle event and the time until its commencement. Timeframes shorter or longer than 500 ms may be used without departing from the intended scope of the invention. Execution of algorithm 100 enables the MGU 26 to be used as a fast actuator, as that term is defined herein. The MGU may operate as a generator during some transient events, thus allowing energy regeneration or charging of an onboard energy storage system (ESS) 25, e.g., a rechargeable battery module, or as a motor if so required. In other transient events, e.g., an auto start, the MGU 26 may be used as a motor.

The controller 37 may be programmed with or otherwise has access to the algorithm 100, with the algorithm explained in detail below with reference to FIG. 2. The vehicle 10 includes an accelerator pedal 15 having a detectable pedal position (arrow P_{X}), with the pedal position transmitted to and/or read by the motor controller 37 as an available input signal for determining, for example, when to initiate, release, or prevent an auto stop/start event, a transmission gear shift, a fuel injector cycling event, etc. Controller 37 may also include or have access to calibrated lookup tables 60 and 70, also described below with reference to FIG. 2.

Still referring to FIG. 1, the engine 12 includes a crankshaft (not shown) and an output member 20. The transmission 14 has an input member 22 and output member 24. The output member 20 of engine 12 may be selectively connected to the input member 22 of the transmission 14 via one or more torque transfer mechanisms or clutches 18. The transmission 14 may be configured as an electrically-variable transmission (EVT), a conventional multi-speed transmission, or any other suitable power transmission capable of transmitting propulsive torque to a set of road wheels 16 via output member 24. The output member 24 of the transmission 14 rotates at output speed (N_{O}) and output torque (T_{O}) in response to a speed request of a driver of vehicle 10 entered via pedal 15 or otherwise.

Within the scope of the invention, the MGU 26 is configured as a multi-phase AC induction-type electric machine or induction motor, with the MGU having a sufficient voltage rating for propelling the vehicle 10, e.g., approximately 60 volts to approximately 300 volts or more depending on the required design. The MGU 26 may be electrically-connected to the ESS 25, for example via a direct current (DC) bus 29, a voltage inverter or power inverter module (PIM) 27, and an alternating current (AC) bus 29A. The ESS 25 may be selectively recharged using the MGU 26 when the MGU is operating in its capacity as a generator, as noted above, such as by capturing energy when the MGU is used as an actuator during the transient vehicle event in accordance with algorithm 100, during a regenerating event, or otherwise.

In one embodiment, the MGU 26 may be used to selectively rotate a belt 23 of engine 12, or another suitable portion thereof, thereby cranking and starting the engine during an auto start event, as will be understood by those of ordinary skill in the art. However, other designs may be used to start the engine 12, e.g., a starter motor, without departing from the intended scope of the invention. The vehicle 10 may also include an auxiliary power module (APM) 28, e.g., a DC-DC power converter, which is electrically connected to the ESS 25 via the DC bus 29. The APM 28 may also be electrically connected to an auxiliary battery (AUX) 41, e.g., a 12-volt DC battery, via a low-voltage bus 19, and adapted for energizing one or more auxiliary systems 45 aboard the vehicle 10. The particular manner in which the various connected devices are configured and operate does not affect the torque command structure of the present invention as detailed in FIGS. 2 and 3, as explained below.

Still referring to FIG. 1, as noted above the controller 37 may be configured as a single device or a distributed control device that is electrically connected to or otherwise placed in electrical communication with each of the engine 12, the MGU 26, and the ESS 25, as well as the APM 28, the PIM 27, and the auxiliary battery 41 when the vehicle 10 is so configured, via a control channel 51, as illustrated in FIG. 1 by dashed lines. Control channel 51 may include any required transfer conductors, e.g., a hard-wired or wireless control link(s) or path(s) suitable for transmitting and receiving the necessary electrical control signals for proper power flow control and coordination aboard the vehicle 10. The controller 37 may include such control modules and capabilities as might be necessary to execute all required power flow control functionality aboard the vehicle 10 in the desired manner.

The controllers 37, 37T may be configured as a digital computer having a microprocessor or central processing unit, read only memory (ROM), random access memory (RAM), electrically-erasable programmable read only memory (EEPROM), high speed clock, analog to digital (A/D) and digital to analog (D/A) circuitry, and input/output circuitry and devices (I/O), as well as appropriate signal conditioning and buffer circuitry. Any algorithms resident in the controller 37 or accessible thereby, including the torque command structure-enabling algorithm 100 as described below with reference to FIG. 2, can be stored in ROM and automatically executed by the controller to provide the required functionality.

As used herein, the term “fast actuator” refers to the selective use of the MGU 26 to facilitate execution of one or more of the transient vehicle events, e.g., to retard or apply a negative torque to a particular portion of the vehicle 10, to apply a positive torque when an increase in torque is required, etc., relative to conventional methods or actuating systems to thereby facilitate the transient event. As will be understood by those of ordinary skill in the art, vehicle-based AC induction machines such as the MGU 26 are at their most energy efficient level whenever electromagnetic flux is minimized.

Therefore, electromagnetic flux is ordinarily maintained at a calibrated minimal level at all times, with the level being suitable for the immediate torque demand. For the previously mentioned transient vehicle events, conventional actuating methods include closing of an electronic throttle valve for fuel regulation, throttle control during a transmission gear shift, etc. Such methods, relative to the use of MGU 26 as an actuator, are herein referred to as “slow” actuators relative to the potential speed and immediately available torque of the MGU.

The MGU 26, acting as a “fast” actuator within the scope of the invention, may act in approximately 25 milliseconds (ms) to approximately 50 ms, while conventional or “slow” actuator methods may take approximately 100 ms or more to complete. The controller 37 thus executes the algorithm 100 in anticipation of a transient vehicle event as described above, e.g., less than approximately 500 ms prior to commencement of the transient vehicle event according to one embodiment.

Execution of algorithm 100 produces a pair of different motor torque commands, i.e., an immediate torque and a predicted torque, and increases the electromagnetic flux (Φ_{M}) of the MGU 26 so that the MGU may be used as a fast actuator, e.g., to either more rapidly increase or decrease MGU torque as needed, to effectuate a relatively smooth gear shift of the transmission 14, to ensure that spark level is maintained at an optimal level, i.e., to prevent spark arrest from occurring, if so desired. The MGU 26, when acting as a generator, may also be used to recharge the ESS 25 during certain transient vehicle events.

Referring to FIG. 2, execution of algorithm 100 begins with step 102, wherein the event signal 11 is automatically generated. When a distributed controller is used, step 102 may entail transmitting the event signal 11 to the controller 37 from the controller 37T for processing by the controller 37, or when a single or integrated controller is used, the event signal may be internally generated and processed by the controller 37. However generated, the event signal 11 indicates the imminent commencement of one of a plurality of predetermined transient vehicle events as noted above.

In one embodiment, the predetermined transient vehicle event is one of an auto start of the engine 12, a shift of the transmission 14, and a fuel event, e.g., a fuel injection cycling of injector system 13 shown in FIG. 1, although other transient vehicle events that may also be assisted by the MGU 26 may be executed without departing from the intended scope of the invention. Event signal 11 may be generated in response to a collective set of threshold values, e.g., pedal position (P_{X}), engine speed (N_{E}), transmission output speed (N_{O}), transmission output torque (T_{O}), etc., as shown in FIG. 1. Once the event signal 11 has been generated, the algorithm 100 proceeds to step 104.

At step 104, the algorithm 100 processes the event signal 11 to determine a predicted motor output torque required during the upcoming transient vehicle event, e.g., via calculation and/or by accessing a lookup table 60 as shown in FIG. 1. Processing includes automatically and rapidly increasing the flux (Φ_{M}) of the MGU 26 to a calibrated maximum value (CAL_{MAX}) suitable for meeting the predicted motor output torque level. That is, an amount of flux is produced that corresponds to the predicted torque command. Increase in flux occurs at a calibrated duration or point in time in advance of an initiation and occurrence of the transient vehicle event, and not concurrently therewith as with conventional systems.

The increase in flux to the MGU 26 is sufficient for at least meeting the maximum required predicted torque during the transient vehicle event. For example, in an embodiment in which approximately −30 N/m of immediate torque request is required for a particular transient vehicle event, algorithm 100 might increase the flux of MGU 26 to provide between −30 Newton meters (Nm) and approximately −50 Nm or more of torque request in order to ensure sufficient torque is available. That is, motor efficiency is temporarily traded for rapid motor performance. In any event, with increased flux the MGU 26 could provide torque between approximately +50 Nm and −50 Nm, or more/less as needed.

In one embodiment, the calibrated duration before the initiation of the transient event is at least approximately 500 milliseconds, as noted above, ensuring that the flux is at a maximum value at the moment the transient vehicle event initiates. The amount of flux (Φ_{M}) required for the MGU 26 to function as a fast actuator may vary with the type of transient vehicle event, and therefore may be stored as calibrated values in a lookup table 70 (see FIG. 1) that the controller 37 can quickly reference. However, magnetic flux values may also be instantaneously calculated by the controller 37 using the various vehicle operating values noted above without departing from the intended inventive scope.

At step 106, the controller 37 actuates the MGU 26, i.e., operates the MGU as a fast actuator to facilitate execution of the transient vehicle event using the immediate torque command. Pre-fluxing per step 104 allows such actuation to occur relatively rapidly. For example, step 106 might entail using the MGU 26 to retard or slow the engine 12 without altering the spark sequence, i.e., while keeping engine spark at an optimal level, or may augment or increase crankshaft torque as needed depending on the operating mode. Step 106 might also entail using the MGU 26 to start the engine 12 during an auto start event, or to provide reactive torque or smooth the feel of a transmission shift event. Also, when the MGU 26 is acting as a fast actuator, it may do so in its capacity as a generator for some transient events, and as a motor for others, e.g., auto start events. Therefore, step 106 may include energy regeneration, i.e., the capturing energy by the MGU 26 during the transient vehicle event and the selective charging of the ESS 25, when the MGU is operating as a generator.

At step 108, the algorithm 100 determines whether the transient vehicle event has concluded, again using the event signal 11. Step 108 continues in a loop with step 106 until it is determined that the transient vehicle event is complete, at which point the algorithm 100 proceeds to step 110.

At step 110, the controller 37 determines that steady state conditions exist upon completion of the transient event, and automatically lowers the magnetic flux of the MGU 26 to a calibrated level. When the algorithm 100 is inactive, the predicted and immediate torque commands are set equal to each other, as evident from the above disclosure. This calibrated level is allowed to vary so that is remains sufficient for meeting any immediate torque requirements.

That is, when the algorithm 100 is inactive, but the flux is still dynamic, the controller 37 commands flux required to meet any immediate torque demands. If the immediate torque command changes while the algorithm 100 is inactive, the controller 37 still changes its flux target in the usual manner, i.e., a time delay will occur between the change in the flux target and the actual flux level as noted above. In this manner, the MGU 26 operates at a relatively high efficiency in steady state, while still meeting any immediate torque requirements.

Referring to FIG. 3, the dual-value torque command structure enabled by the algorithm 100 of FIG. 2 may be represented as a set of torque curves 30, which are plotted with respect to the event signal 11. Event signal 11, which is generated at step 102 of algorithm 100 (see FIG. 2), may be an on/off state signal, represented in FIG. 3 as a 1 and a 0 state, respectively. An event signal 11 having a zero (0) value indicates steady state operation of the MGU 26, which occurs until point A. At point A, the event signal 11 changes state, remaining active, i.e., a one (1) value, until point B when the transient event is concluded. Thereafter, the event signal 11 returns to a zero (0) state.

The torque command structure provided by torque curves 30 provides two different torque commands to the MGU 26, as noted above, i.e., an immediate motor output torque, represented by line 34, and a predicted motor output torque, represented by line 35. Axis 40 of FIG. 3 represents a motor output torque of zero. Therefore, up until point A, the immediate and predicted motor output torque of lines 34 and 35 respectively track each other, and may be maintained within a calibrated range of the axis 40.

Upon a state change of the event signal 11, i.e., when a future transient vehicle event is predicted but has not yet commenced, predicted motor output torque (line 35) immediately increases to a calibrated maximum value, i.e., CAL_{MAX}, suitable for meeting the predicted torque level required during the transient event. That is, as actual torque capability requires time to build, flux is rapidly increased to the MGU 26 in advance of the transient vehicle event, such that the predicted torque is immediately available when the transient event commences. Conventional systems continue to maintain a minimal flux value for meeting immediate torque requirements, i.e., a most efficient value, and utilize devices other than the MGU to provide the required assistance during the transient event. Using conventional flux control methods, the transient event may already be over, or substantially so, before immediate torque can be increased sufficiently for meeting the torque demand.

If the maximum expected immediate torque (line 34) during the transient vehicle event is expected to equal, for example, −30 Nm, the motor controller 27 may increase flux to the MGU 26 to provide at least −30 Nm of torque, and as much as 200% or more of the expected required torque, to ensure rapid application of torque from the MGU. The actual variance between the immediate motor output torque (line 34) and the predicted motor output torque (line 35) when the predicted motor output torque is at the calibrated maximum value (CAL_{MAX}) may vary with the intended design, as the greater the difference, the greater the loss in efficiency, albeit with a potentially improved response time.

At point B, when the transient vehicle event is complete, i.e., step 108 of FIG. 2, the algorithm 100 immediately decreases the flux of the MGU 26, as indicated by line 35 and discussed above with reference to step 110. Note that line 35 approximates line 34 upon completion of the transient event. As will be understood by those of ordinary skill in the art, execution of algorithm 100 may optimize regeneration aboard the vehicle 10, while potentially improving response times and/or feel of the transient event.

While the best modes for carrying out the invention have been described in detail, those familiar with the art to which this invention relates will recognize various alternative designs and embodiments for practicing the invention within the scope of the appended claims.

1. A method of controlling a motor generator unit (MGU) aboard a vehicle having a controller, the method comprising:
generating an event signal using the controller, wherein the event signal predicts an occurrence of a predetermined transient vehicle event;
processing the event signal using the controller to thereby determine a predicted level of motor output torque required from the MGU during the transient vehicle event;
automatically increasing an amount of electromagnetic flux of the MGU to a calibrated threshold level prior to commencement of the transient vehicle event, the calibrated threshold level being sufficient for generating the predicted level of motor output torque; and
using the MGU to facilitate an execution of the transient vehicle event.

2. The method of claim 1, the vehicle further including an energy storage system (ESS), the method further comprising:
using the MGU as a generator to selectively recharge the ESS during the transient vehicle event.

3. The method of claim 1, the vehicle further including an engine having an engine speed, a transmission having a transmission output speed, and an accelerator pedal having an accelerator pedal position, the method further comprising:
determining at least one of: the engine speed, the transmission output speed, and the accelerator pedal position prior to generating the event signal.

4. The method of claim 1, wherein the transient vehicle event includes at least one of: an auto start event, a transmission gear shift event, and a fuel injector cycling event.

5. The method of claim 1, wherein determining a predicted level of motor output torque includes one of: calculating the predicted level of motor output torque using the event signal, and accessing a first lookup table via the controller.

6. The method of claim 5, wherein automatically increasing an amount of electromagnetic flux of the MGU to a calibrated threshold level includes accessing a second lookup table via the controller, selecting the calibrated threshold level from the second lookup table, and increasing the amount of electromagnetic flux until the calibrated threshold level is attained.

7. A vehicle comprising:
a motor generator unit (MGU); and
a controller adapted for generating and processing an event signal that predicts an occurrence of a predetermined transient vehicle event, the controller being adapted for determining a predicted level of motor output torque required from the MGU during the transient vehicle event by processing the event signal, and for controlling the MGU to facilitate an execution of the transient vehicle event;
wherein the motor controller includes an algorithm adapted for automatically increasing an amount of electromagnetic flux of the MGU to a calibrated threshold level sufficient for generating the predicted level of motor output torque prior to commencement of the transient vehicle event.

8. The vehicle of claim 7, further comprising an energy storage system (ESS), wherein the controller automatically charges the ESS using the MGU as a generator during the transient vehicle event.

9. The vehicle of claim 7, further comprising an engine having an engine speed, a transmission having a transmission output speed, and an accelerator pedal having an accelerator pedal position, wherein the event signal is determined using at least one of: the engine speed, the transmission output speed, and the accelerator pedal position.

10. The vehicle of claim 7, wherein the transient vehicle event transient includes one of: an auto start event, a transmission gear shift event, and a fuel injector cycling event.

11. The vehicle of claim 7, wherein the controller is adapted for determining a predicted level of motor output torque via at least one of: calculating the predicted level of motor output torque using the event signal, and accessing a first lookup table via the motor controller.

12. The vehicle of claim 7, wherein the controller is adapted for automatically increasing an amount of electromagnetic flux of the MGU to a calibrated threshold level by accessing a second lookup table, selecting the calibrated threshold level from the second lookup table, and automatically increasing the amount of electromagnetic flux until the calibrated threshold level is attained.

13. A controller adapted for controlling a motor generator unit (MGU) aboard a vehicle, the controller comprising:
a host machine in communication with the transmission controller; and
an algorithm executable by the host machine, and adapted for automatically increasing an amount of electromagnetic flux of the MGU to a calibrated threshold level prior to commencement of a predetermined transient vehicle event, the calibrated threshold level being sufficient for generating the predicted level of motor output torque;
wherein the controller is adapted for generating an event signal that predicts an occurrence of the predetermined transient vehicle event, for processing the event signal to determine a predicted level of motor output torque required from the MGU during the transient vehicle event, and for controlling the MGU to facilitate an execution of the transient vehicle event.

14. The controller of claim 13, wherein the vehicle includes an energy storage system (ESS), and wherein the controller is adapted to automatically charge the ESS during the transient vehicle event using the MGU.

15. The controller of claim 13, wherein the vehicle includes an engine having an engine speed, a transmission having a transmission output speed, and an accelerator pedal having an accelerator pedal position, wherein the event signal is determined by at least one of: the engine speed, the transmission output speed, and the accelerator pedal position.

16. The controller of claim 13, wherein the transient vehicle event includes one of: an auto start event, a transmission gear shift event, and a fuel injector cycling event.

17. The controller of claim 13, wherein the controller is adapted for determining a predicted level of motor output torque via at least one of: calculating the predicted level of motor output torque using the event signal, and accessing a first lookup table.

18. The controller of claim 13, wherein the controller is adapted for automatically increasing an amount of electromagnetic flux of the MGU to a calibrated threshold level by accessing a second lookup table, selecting the calibrated threshold level from the second lookup table, and automatically increasing the amount of electromagnetic flux until the calibrated threshold level is attained.
